(19) United States
(12) Patent Application Publication
(10) Pub. No.: US 2024/0182096 A1
(43) Pub. Date: Jun. 6, 2024

(54) HAND TRUCK FOR SLABS

(71) Applicant: William Dee MARTIN, Phoenix, AZ (US)

(72) Inventor: William Dee MARTIN, Phoenix, AZ (US)

(21) Appl. No.: 18/528,388

(22) Filed: Dec. 4, 2023

Related U.S. Application Data
(60) Provisional application No. 63/430,228, filed on Dec. 5, 2022.

(51) Int. Cl. B62B 3/10; B62B 3/02; B62B 3/12

(52) U.S. Cl. CPC B62B 3/10; B62B 3/02; B62B 3/12; B62B 2205/14; B62B 2205/30

(57) ABSTRACT

A hand truck orients a slab in a for-aft direction with upper and lower slots formed by upper and lower pairs of arms. The hand truck has a pair of wheels, an upright frame, a platform and a handle. The upright frame and the platform pivoting about an axle a rest orientation and a tilted orientation. A lower pair of lower arms is coupled to the frame and positioned at the platform and oriented to extend forwardly from the upright frame and the pair of wheels. The lower pair of lower arms forms a lower open-ended slot. An upper pair of upper arms is coupled to the frame and spaced-apart from the lower pair of lower arms, and oriented to extend forwardly from the upright frame and the pair of wheels. The upper pair of upper arms forming an upper open-ended slot.

### PRIORITY CLAIM

Priority is claimed to U.S. Provisional Patent Application No. 63/430,228, filed Dec. 5, 2022, which is hereby incorporated herein by reference.

### BACKGROUND

Handling and moving larger, flat items, such as windows, doors and slabs, can be challenging. Hand trucks are typically configured to handle such items flat against the upright of the hand truck, making for a wide load. It can be difficult to see around the wide load while moving the item. In addition, it can be difficult for the wide load to clear other objects and doorways.

### BRIEF DESCRIPTION OF THE DRAWINGS

Features and advantages of the invention will be apparent from the detailed description which follows, taken in conjunction with the accompanying drawings, which together illustrate, by way of example, features of the invention; and, wherein:

FIG. 1 is a side view of an example hand truck in accordance with one embodiment, shown with a slab and in a rest orientation.

FIG. 2 is a side view of the hand truck of FIG. 1, shown with the slab and in a tilted orientation.

FIG. 3 is a top view of the hand truck of FIG. 1, shown with the slab and in the rest orientation.

FIG. 4 is a front view of the hand truck of FIG. 1, shown with the slab and in the rest orientation.

FIG. 5 is a side view of the hand truck of FIG. 1, shown in the rest orientation.

FIG. 6 is a side view of another example hand truck in accordance with another embodiment, shown with upper and lower pairs of arms in a retracted orientation, and a third wheel in a retracted orientation.

FIG. 7 is a schematic side view of the hand truck of FIG. 6, shown with the upper and lower pairs of arms in an extended orientation, and the third wheel in an extended orientation.

FIG. 8 is a side view of another example hand truck in accordance with another embodiment, shown with upper and lower pairs of arms in an attached configuration, and a third wheel in an attached configuration.

FIG. 9 is a schematic side view of the hand truck of FIG. 8, shown with the upper and lower pairs of arms in an attached configuration, and the third wheel in an attached configuration.

Reference will now be made to the exemplary embodiments illustrated, and specific language will be used herein to describe the same. It will nevertheless be understood that no limitation of the scope of the invention is thereby intended.

### DETAILED DESCRIPTION

Before invention embodiments are disclosed and described, it is to be understood that no limitation to the particular structures, process steps, or materials disclosed herein is intended, but also includes equivalents thereof as would be recognized by those ordinarily skilled in the relevant arts. It should also be understood that terminology employed herein is used for the purpose of describing particular examples only and is not intended to be limiting. The same reference numerals in different drawings represent the same element. Numbers provided in flow charts and processes are provided for clarity in illustrating steps and operations and do not necessarily indicate a particular order or sequence. Unless defined otherwise, all technical and scientific terms used herein have the same meaning as commonly understood by one of ordinary skill in the art to which this disclosure belongs.

An initial overview of the inventive concepts is provided below and then specific examples are described in further detail later. This initial summary is intended to aid readers in understanding the examples more quickly, but is not intended to identify key features or essential features of the examples, nor is it intended to limit the scope of the claimed subject matter.

The invention provides a hand truck with a for-aft configuration, rather than a lateral configuration, to handle and move large, flat items, such as slabs. The slabs can be any type of slab, such as door(s), windows(s), plywood, security screen(s), etc. In one aspect, the slab(s) can weigh over 100 lbs. In another aspect, the slab(s) can have a height and a width or length greater than 4 ft, 5 ft, 6 ft or 7 ft. In another aspect, the slab(s) can have a thickness less than 12 in, 10 in, 8 in, 6 in, 4 in, 2 in or 1 in.

The hand truck can have upper and lower pairs of arms forming upper and lower slots that extend forward of the hand truck. Thus, a slab can be received by the hand truck in the slots and between the arms in a for-aft configuration, or with its long dimension extending forwardly. Thus, it is possible to see around the item when driving the hand truck. The hand truck can allow the slab(s) to be moved and maneuvered without lifting. In addition, the hand truck can have an elevated rear wheel onto which the hand truck can pivot. Thus, the weight of the slab can be carried by three wheels.

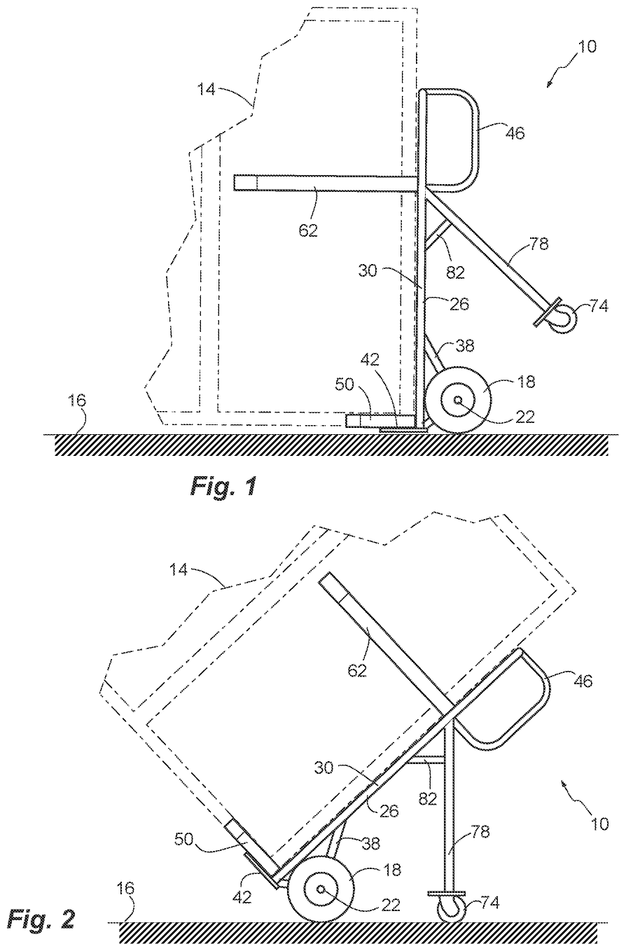

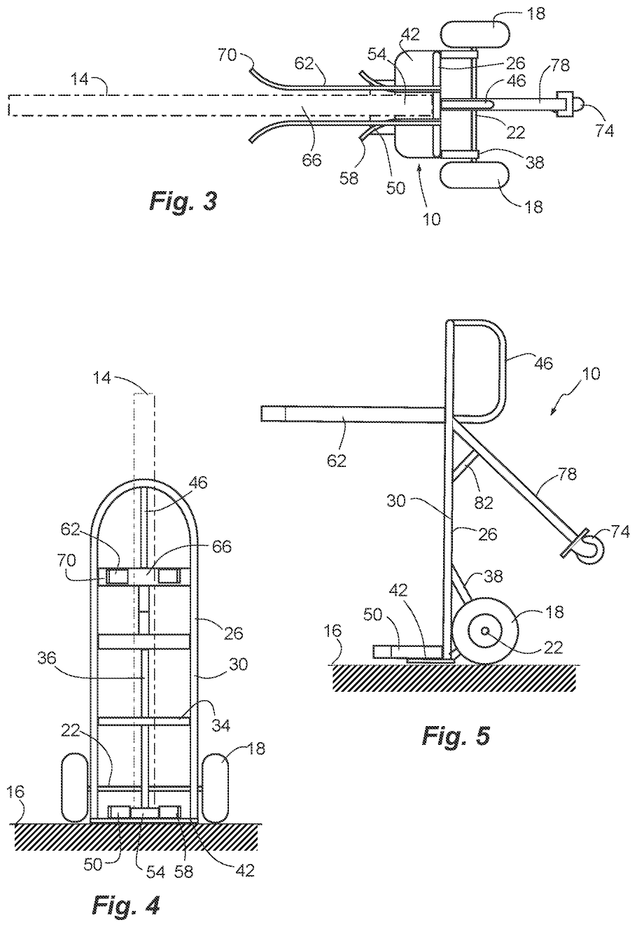

Referring to FIGS. 1-5, a hand truck 10 is shown by way of example for moving at least one slab 14 on a support surface 16, such as the ground. The hand truck 10 can be used to manually transport an item, such as a slab 14. The hand truck 10 may also be referred to as a hand trolley, dolly, stack truck, trundler, box cart, sack barrow, cart, sack truck, two-wheeler, or bag barrow. The slab 14 can be an item with a height and a width or length much greater than thickness. Examples of a slab 14 can include a door, a window, plywood, or a security screen. Such slab 14 can have substantial weight, such as over 100 lbs, and a height and a width greater than 4 ft, which makes manual handling difficult.

The hand truck 10 can have a pair of wheels 18 spaced-apart laterally and rotatable about an axle 22. In one aspect, the wheels 18 can be inflatable tires. In another aspect, the wheels 18 can be a solid polymer material.

An upright frame 26 can be coupled to the wheels 18 and the axle 22. The frame 26, or a majority thereof, can be positioned forward of the pair of wheels 18 and the axle 22. The frame 16 can be oriented to extend upwardly. The frame 26 can have opposite upright members 30 and intermediate spars 34 extending between the upright members 30. In one aspect, a spine 36 can be positioned between the upright members 30 and can be coupled to the spars 34. In another aspect, the frame 26 can be formed of metal, such as steel, can be formed as tubing and/or bar bent and/or welded together. The upright members 30 can be formed by a single piece of tubing bent to form a top of the frame with a broad arch. A pair of braces 38 can extend from the upright members 30 to the axle 22. Bearings can be coupled in elbows of the braces 38 to receive the axle 22.

A platform 42 can be coupled to the wheels 18 and the frame 26. The platform 42 can be positioned forward of the pair of wheels 18 and proximal the ground 16. A bottom end of the frame 26 and bottom ends of the upright members 30 can be attached to the plate 42, such as by welding.

A handle 46 can coupled to and can extend from an upper end of the frame 26. The handle 46 can extend rearward of the frame 26 or the upright members 30. The handle 46 can be positioned over the wheels 18.

In one aspect, the frame 26 can comprise and can be formed of the upright members 30, the spars 34, the spine 36, the braces 38, the platform 42 and the handle 46.

The frame 26 and the platform 42 can pivoting about the axle 22 during use. The frame 26 and the platform 42 can have at least two orientations, including: 1) a rest orientation, as shown in FIGS. 1, 4 and 5, and 2) a tilted orientation, as shown in FIG. 2. In the rest orientation, the platform 42 can abut to the ground 16 and the frame 26 can extend vertically. In the tilted orientation, the hand truck 10 is configured to move the slab 14. Thus, in the tilted orientation, the platform 42 can be tilted upward and elevated above the ground 16 at an incline. Similarly, the frame 26 can be tilted rearward at an incline. A center of gravity of the slab 14 can be transferred from forward of the axle 22 to rearward of the axle 22 in the tilted orientation.

A lower pair of lower arms 50 can be coupled to the frame 26. The lower arms 50 can be positioned at the platform 42 and adjacent the ground 16 in the rest orientation. The lower arms 50 can be spaced-apart from one another to form a gap to receive the slab 14 in the gap and between the lower arms 50. The lower arms 50 can be oriented to extend forwardly from the frame 26 and the pair of wheels 18. The lower arms 50 can be open at a distal end to form a lower open-ended slot 54. In one aspect, the lower arms 50 can have a flared opening 58 at the distal end to facilitate inserting the slab 14 into the slot 54.

An upper pair of upper arms 62 can be coupled to the frame 26. In one aspect, the upper arms 62 can be attached to the spine 36 and/or a spar 34. The upper arms 62 can be positioned closer to the handle 46 and spaced-apart from the lower pair of lower arms 50. The upper arms 62 can be oriented to extend forwardly from the frame 26 and the pair of wheels 18. The upper arms 62 can be spaced-apart from one another to form a gap to receive the slab 14 in the gap and between the upper arms 62. The upper pair of upper arms 62 can form an upper open-ended slot 66. In one aspect, the upper arms 62 can have a flared opening 70 at the distal end to facilitate inserting the slab 14 into the slot 66.

The upper and lower arms 62 and 50 can be vertically aligned. Similarly, the upper and lower slots 66 and 54 can be vertically aligned. Thus, an upright slab 14 can be received in the slots 54 and 66 and on the platform 42 of the hand truck 10. The upper and lower arms 62 and 50 can extend horizontally forward beyond the platform 42 to receive a wide or long slab 14. The upper arms 62 can extend horizontally forward farther than the lower arms 50 so that the upper arms 62 can receive the slab 14 before the lower arms 50 to facilitate engagement of the slab 14 by the hand truck 10.

In another aspect, a third wheel 74 can coupled to the frame 26. The third wheel 74 can be coupled by a column 78 extending between the frame 26 and the third wheel 74. In addition, a brace 82 can extend between the column 78 and the frame 26. The column 78 and the brace 82 can be attached to the spine 36 and/or the spars 34. The third wheel 74 can be positioned off of the ground 16 when the frame 26 is in the rest orientation (FIG. 1), and positioned on the ground 16 in the tilted orientation (FIG. 2). Thus, the weight of the slab 14 can rest on the pair of wheels 18 and the third wheel 74 in the tilted orientation. The column 78 can be oriented vertically when the frame 26 is in the tilted orientation, as shown in FIG. 2.

In use, the slab 14 can be oriented upright and vertical while the hand truck 10 is positioned at a proximal lateral end of the slab 14. The hand truck 10 can be slid forward towards the slab 14 while the slab 14 is received in the slots 66 and 54 and between the upper and lower arms 62 and 50. A proximal end of the slab 14 can be tilted upward, while the hand truck 10 is slid forward towards the slab 14 and the platform 42 is slid under the proximal end of the slab 14. The slab 14 can be tilted back so that the proximal lateral end of the slab 14 rests on the platform 42. The hand truck 10 can be tilted from the rest orientation to the tilted orientation while carrying the slab 14 so that the slab 14 is tilted along with the hand truck 10. The upper and lower arms 62 and 50 can support the slab 14 on the hand truck 10 and can resist tipping of the slab 14 with respect to the hand truck 10. The hand truck 10 and the slab 14 can be tilted until the third wheel 74 rests on the ground 16, and the weight of the slab 14 and the hand truck 10 rest on the pair of wheels 18 and the third wheel 74. The hand truck 10 and slab 14 can be moved on the pair of wheels 18, or on all three wheels, to a different location. Because of the for-aft orientation of the slab 14, i.e. with the long dimensions of the slab 14 oriented for-aft rather than laterally, a user behind the hand truck 10 can see forwardly to steer the hand truck 10.

### Second Exemplary Embodiment

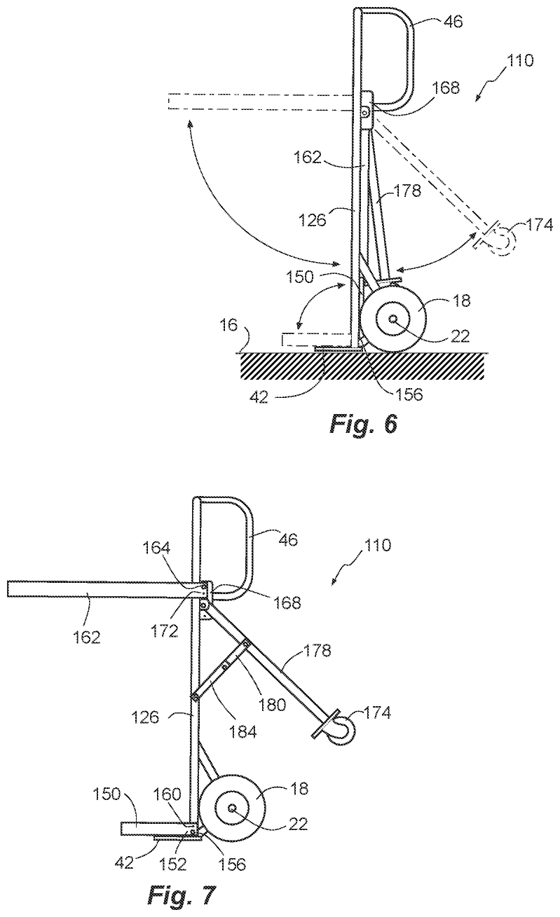

In another aspect, the hand truck 110 can have at least two configurations, including: 1) a slab configuration, as described above (FIG. 7), and 2) a standard hand truck configuration without the arms 162 and 150 and/or the third wheel 174 (FIG. 6). In one aspect, the arms 162 and 150 and/or the third wheel 174 can be pivotally coupled to the hand truck 110, and can pivot between the configurations.

In one aspect, the upper pair of upper arms 162 can be pivotally coupled to the upright frame 126. The upper pair of upper arms 162 can pivot between at least two orientations, including: 1) and extended orientation (FIG. 7), and 2) a retracted orientation (FIG. 6). In the extended orientation, the upper pair of upper arms 162 can extend forward when the hand truck 110 is in the rest orientation. In the retracted orientation, the upper pair of upper arms 162 can be positioned against the upright frame 126, as shown in FIG. 6. The upper pair of upper arms 162 can pivot upward to the extended orientation, and downward to the retracted orientation. The upper pair of upper arms 162 can pivot about a pivot 164.

The hand truck 110 can also include a lock 168 to lock the upper pair of upper arms 162 in a selected orientation. In one aspect, the lock 168 can comprise a pin 172 receivable in bores associated with the upright frame 126 and the upper pair of upper arms 162. Thus, the pin 172 can be removed to reorient the arms 162; then reinserted to lock the arms 162 in position.

In another aspect, the lower pair of lower arms 150 can be pivotally coupled to the upright frame 126. The lower pair of lower arms 150 can pivot between at least two orientations, including: 1) an extended orientation (FIG. 7), and 2) a retracted orientation (FIG. 6). In the extended orientation, the lower pair of lower arms 150 can extend forward when the hand truck 110 is in the rest orientation. In the retracted orientation, the lower pair of lower arms 150 can be positioned against the upright frame 126. The lower pair of lower arms 150 can pivot downward to the extended orientation, and upward to the retracted orientation. The lower pair of lower arms 150 can pivot about a pivot 152.

The hand truck 110 can also include a lock 156 to lock the lower pair of lower arms 150 in a selected orientation. In one aspect, the lock 156 can comprise a pin 160 receivable in bores associated with the upright frame 126 and the lower pair of lower arms 150. Thus, the pin 160 can be removed to reorient the arms 150; then reinserted to lock the arms 150 in position.

In another aspect, the third wheel 174 can be pivotally coupled to the upright frame 126. The third wheel 174 can pivot between at least two orientations, including: 1) an extended orientation (FIG. 7), and 2) a retracted orientation (FIG. 6). In the extended orientation, the column 178 and the third wheel 174 can extend from the upright frame 126. In the retracted orientation, the column 178 and the third wheel 174 can be positioned against the upright frame 126. The column 178 and the third wheel 174 can pivot upward to the extended orientation, and downward to the retracted orientation.

The hand truck 110 can also include a lock 180 to lock the third wheel 174 and the column 178 in a selected orientation. In one aspect, the lock 180 can comprise a foldable brace 184 between the upright frame 126 and the column 178.

### Third Exemplary Embodiment

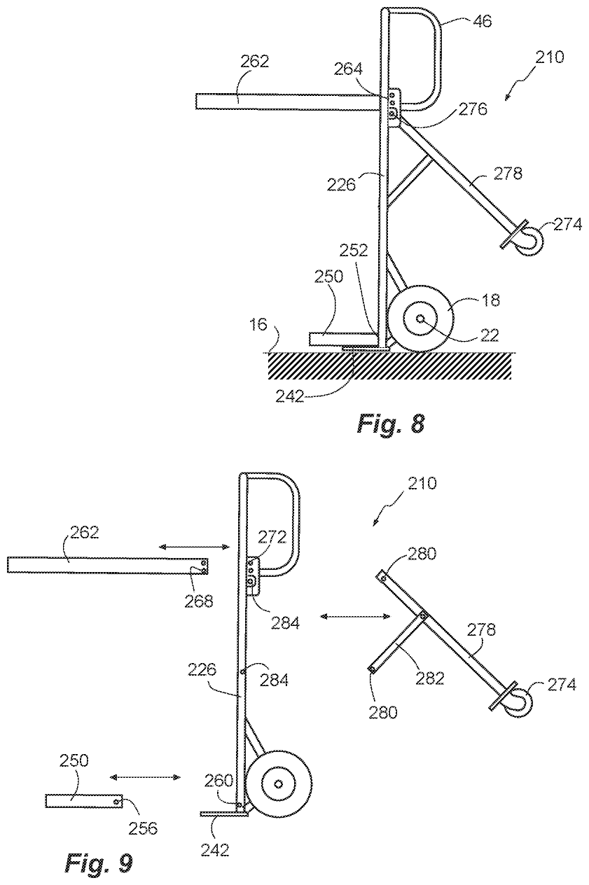

In another aspect, the hand truck 210 can have at least two configurations, including: 1) a slab configuration (FIG. 8), as described above, and 2) a standard hand truck configuration (FIG. 9) without the arms 262 and 250 and/or the third wheel 274. In one aspect, the arms 262 and 250 and/or the third wheel 174 can be removably coupled to the hand truck 210.

In one aspect, the upper pair of upper arms 262 can be removably coupled to the upright frame 226. The hand truck 210 can have a connector 264 attaching the upper pair of upper arms 262 to the upright frame 226. In one aspect, the connector 264 can comprise a pair of pins 268 or bolts receivable in bores 272 associated with the upright frame 226 and the upper pair of upper arms 262. Thus, the pins 268 can be removed to remove the arms 262, or inserted to attach the arms 262.

In another aspect, the lower pair of lower arms 250 can be removably coupled to the upright frame 226 and/or the platform 242. The hand truck 210 can have a connector 252 attaching the lower pair of lower arms 250 to the upright frame 226 and/or the platform 242. In one aspect, the connector 252 can comprise at least one pin 256 or bolt receivable in bores 260 associated with the upright frame 226 and the lower pair of lower arms 250. Thus, the pin 256 can be removed to remove the arms 250, or inserted to attach the arms 250.

In another aspect, the third wheel 274 can be removably coupled to the upright frame 226. The hand truck 210 can have a connector 276 attaching the third wheel 274 and the column 278 to the upright frame 226. In one aspect, the connector 276 can comprise a pair of pins 280 or bolts receivable in bores 284 associated with the upright frame 226 and the column 278 and the brace 282 of the third wheel 274. Thus, the pins can 280 be removed to remove the third wheel 274 and the column 278, or inserted to attach the third wheel 274.

As used in this specification and the appended claims, the singular forms “a,” “an” and “the” include plural referents unless the context clearly dictates otherwise. Thus, for example, reference to “a layer” includes a plurality of such layers.

In this disclosure, “comprises,” “comprising,” “containing” and “having” and the like can have the meaning ascribed to them in U.S. Patent law and can mean “includes,” “including,” and the like, and are generally interpreted to be open ended terms. The terms “consisting of” or “consists of” are closed terms, and include only the components, structures, steps, or the like specifically listed in conjunction with such terms, as well as that which is in accordance with U.S. Patent law. “Consisting essentially of” or “consists essentially of” have the meaning generally ascribed to them by U.S. Patent law. In particular, such terms are generally closed terms, with the exception of allowing inclusion of additional items, materials, components, steps, or elements, that do not materially affect the basic and novel characteristics or function of the item(s) used in connection therewith. For example, trace elements present in a composition, but not affecting the composition's nature or characteristics would be permissible if present under the “consisting essentially of” language, even though not expressly recited in a list of items following such terminology. When using an open ended term in the specification, like “comprising” or “including,” it is understood that direct support should be afforded also to “consisting essentially of” language as well as “consisting of” language as if stated explicitly and vice versa.

The terms “first,” “second,” “third,” “fourth,” and the like in the description and in the claims, if any, are used for distinguishing between similar elements and not necessarily for describing a particular sequential or chronological order. It is to be understood that the terms so used are interchangeable under appropriate circumstances such that the embodiments described herein are, for example, capable of operation in sequences other than those illustrated or otherwise described herein. Similarly, if a method is described herein as comprising a series of steps, the order of such steps as presented herein is not necessarily the only order in which such steps may be performed, and certain of the stated steps may possibly be omitted and/or certain other steps not described herein may possibly be added to the method.

The terms “left,” “right,” “front,” “back,” “top,” “bottom,” “over,” “under,” and the like in the description and in the claims, if any, are used for descriptive purposes and not necessarily for describing permanent relative positions. It is to be understood that the terms so used are interchangeable under appropriate circumstances such that the embodiments described herein are, for example, capable of operation in other orientations than those illustrated or otherwise described herein.

The term “coupled,” as used herein, is defined as directly or indirectly connected in an electrical or nonelectrical manner. Objects described herein as being “adjacent to” each other may be in physical contact with each other, in close proximity to each other, or in the same general region or area as each other, as appropriate for the context in which the phrase is used. Occurrences of the phrase “in one embodiment,” or “in one aspect,” herein do not necessarily all refer to the same embodiment or aspect.

As used herein, the term “substantially” refers to the complete or nearly complete extent or degree of an action, characteristic, property, state, structure, item, or result. For example, an object that is “substantially” enclosed would mean that the object is either completely enclosed or nearly completely enclosed. The exact allowable degree of deviation from absolute completeness may in some cases depend on the specific context. However, generally speaking the nearness of completion will be so as to have the same overall result as if absolute and total completion were obtained. The use of “substantially” is equally applicable when used in a negative connotation to refer to the complete or near complete lack of an action, characteristic, property, state, structure, item, or result. For example, a composition that is “substantially free of” particles would either completely lack particles, or so nearly completely lack particles that the effect would be the same as if it completely lacked particles. In other words, a composition that is “substantially free of” an ingredient or element may still actually contain such item as long as there is no measurable effect thereof.

As used herein, “adjacent” refers to the proximity of two structures or elements. Particularly, elements that are identified as being “adjacent” may be either abutting or connected. Such elements may also be near or close to each other without necessarily contacting each other. The exact degree of proximity may in some cases depend on the specific context.

As used herein, the term “about” is used to provide flexibility to a numerical range endpoint by providing that a given value may be “a little above” or “a little below” the endpoint. It is understood that express support is intended for exact numerical values in this specification, even when the term “about” is used in connection therewith.

It is to be understood that the examples set forth herein are not limited to the particular structures, process steps, or materials disclosed, but are extended to equivalents thereof as would be recognized by those ordinarily skilled in the relevant arts. It should also be understood that terminology employed herein is used for the purpose of describing particular examples only and is not intended to be limiting.

Furthermore, the described features, structures, or characteristics may be combined in any suitable manner in one or more examples. In the description, numerous specific details are provided, such as examples of lengths, widths, shapes, etc., to provide a thorough understanding of the technology being described. One skilled in the relevant art will recognize, however, that the invention can be practiced without one or more of the specific details, or with other methods, components, materials, etc. In other instances, well-known structures, materials, or operations are not shown or described in detail to avoid obscuring aspects of the invention.

While the foregoing examples are illustrative of the principles of the invention in one or more particular applications, it will be apparent to those of ordinary skill in the art that numerous modifications in form, usage and details of implementation can be made without the exercise of inventive faculty, and without departing from the principles and concepts described herein. Accordingly, it is not intended that the invention be limited, except as by the claims set forth below.

What is claimed is:

1. A hand truck configured to handle a slab, the hand truck comprising:
a pair of wheels spaced-apart laterally and rotatable about an axle;
an upright frame coupled to the wheels and positioned forward of the pair of wheels and oriented to extend upwardly;
a platform coupled to the wheels and the upright frame and positioned forward of the pair of wheels and proximal the ground;
a handle coupled to an upper end of the upright frame;
the upright frame and the platform pivoting about the axle during use and having at least two orientations, comprising:
a rest orientation in which the platform abuts the ground and the upright frame extends vertically; and
a tilted orientation configured to move the slab in which the platform is tilted upward and elevated above the ground at an incline and the upright frame is tilted rearward at an incline;
a lower pair of lower arms coupled to the upright frame and positioned at the platform and oriented to extend forwardly from the upright frame and the pair of wheels;
the lower pair of lower arms forming a lower open-ended slot;
an upper pair of upper arms coupled to the upright frame and positioned closer to the handle and spaced-apart from the lower pair of lower arms, and oriented to extend forwardly from the upright frame and the pair of wheels;
the upper pair of upper arms forming an upper open-ended slot; and
the upper and lower pairs of arms being vertically aligned and the upper and lower slots being vertically aligned.

2. The hand truck in accordance with claim 1, further comprising:
a third wheel coupled to the upright frame; and
the third wheel being positioned off of the ground in the rest orientation and positioned on the ground in the tilted orientation.

3. The hand truck in accordance with claim 1, further comprising:
the upper pair of upper arms extending farther than the lower pair of lower arms.

4. The hand truck in accordance with claim 1, wherein the upper and lower pairs of arms both extend horizontally forward beyond the platform.

5. The hand truck in accordance with claim 1, further comprising:
the lower pair of lower arms having a flared opening at a distal end; and
the upper pair of upper arms having a flared opening at a distal end.

6. The hand truck in accordance with claim 1, further comprising:
the upper pair of upper arms being pivotally coupled to the upright frame;
the upper pair of upper arms pivoting between at least two orientations, including:
an extended orientation extending forward in the rest orientation; and
a retracted orientation against the upright frame; and
a lock locking the upper pair of upper arms in a selected orientation.

7. The hand truck in accordance with claim 1, further comprising:
the upper pair of upper arms being removably coupled to the upright frame; and
a connector attaching the upper pair of upper arms to the upright frame.

8. The hand truck in accordance with claim 1, further comprising:
the lower pair of lower arms being pivotally coupled to the upright frame;
the lower pair of lower arms pivoting between at least two orientations, including:
an extended orientation extending forward in the rest orientation; and
a retracted orientation against the upright frame; and
a lock locking the lower pair of lower arms in a selected orientation.

9. The hand truck in accordance with claim 1, further comprising:
the lower pair of lower arms being removably coupled to the upright frame and/or the platform; and
a connector attaching the lower pair of lower arms to the upright frame and/or the platform.

10. The hand truck in accordance with claim 1, further comprising:
a third wheel coupled to the upright frame;
the third wheel being pivotally coupled to the upright frame;
the third wheel pivoting between at least two orientations, including:
an extended orientation extending from the upright frame; and
a retracted orientation against the upright frame; and
a lock locking the third wheel in a selected orientation.

11. The hand truck in accordance with claim 1, further comprising:
a third wheel coupled to the upright frame;
the third wheel being removably coupled to the upright frame; and
a connector attaching the third wheel to the upright frame.

12. A hand truck configured to handle a slab, the hand truck comprising:
a pair of wheels spaced-apart laterally and rotatable about an axle;
an upright frame coupled to the wheels and positioned forward of the pair of wheels and oriented to extend upwardly;
a platform coupled to the wheels and the upright frame and positioned forward of the pair of wheels and proximal the ground;
a handle coupled to an upper end of the upright frame;
the upright frame and the platform pivoting about the axle during use and having at least two orientations, comprising:
a rest orientation in which the platform abuts the ground and the upright frame extends vertically; and
a tilted orientation configured to move an item in which the platform is tilted upward and elevated above the ground at an incline and the upright frame is tilted rearward at an incline;
a lower pair of lower arms coupled to the upright frame and positioned at the platform and oriented to extend forwardly from the upright frame and the pair of wheels;
the lower pair of lower arms forming a lower open-ended slot;
an upper pair of upper arms coupled to the upright frame and positioned closer to the handle and spaced-apart from the lower pair of lower arms, and oriented to extend forwardly from the upright frame and the pair of wheels;
the upper pair of upper arms forming an upper open-ended slot;
the upper and lower pairs of arms being vertically aligned and the upper and lower slots being vertically aligned;
a third wheel coupled to the upright frame;
the third wheel being pivotally coupled to the upright frame; and
the third wheel pivoting between at least two orientations, including:
an extended orientation extending from the upright frame;
a retracted orientation against the upright frame; and
a lock locking the third wheel in a selected orientation.

13. The hand truck in accordance with claim 12, further comprising:
the upper pair of upper arms extending farther than the lower pair of lower arms.

14. The hand truck in accordance with claim 12, wherein the upper and lower pairs of arms both extend beyond the platform.

15. The hand truck in accordance with claim 12, further comprising:
the lower pair of lower arms having a flared opening at a distal end; and
the upper pair of upper arms having a flared opening at a distal end.

16. The hand truck in accordance with claim 12, further comprising:
the upper pair of upper arms being pivotally coupled to the upright frame;
the upper pair of upper arms pivoting between at least two orientations, including:
an extended orientation extending forward in the rest orientation; and
a retracted orientation against the upright frame; and
a lock locking the upper pair of upper arms in a selected orientation.

17. The hand truck in accordance with claim 12, further comprising:
the upper pair of upper arms being removably coupled to the upright frame; and
a connector attaching the upper pair of upper arms to the upright frame.

18. The hand truck in accordance with claim 12, further comprising:
the lower pair of lower arms being pivotally coupled to the upright frame;
the lower pair of lower arms pivoting between at least two orientations, including:
an extended orientation extending forward in the rest orientation; and
a retracted orientation against the upright frame; and
a lock locking the lower pair of lower arms in a selected orientation.

19. The hand truck in accordance with claim 12, further comprising:
the lower pair of lower arms being removably coupled to the upright frame and/or the platform; and
a connector attaching the lower pair of lower arms to the upright frame and/or the platform.

20. A hand truck configured to handle a slab, the hand truck comprising:
a pair of wheels spaced-apart laterally and rotatable about an axle;
an upright frame coupled to the wheels and positioned forward of the pair of wheels and oriented to extend upwardly;
a platform coupled to the wheels and the upright frame and positioned forward of the pair of wheels and proximal the ground;
a handle coupled to an upper end of the upright frame;
the upright frame and the platform pivoting about the axle during use and having at least two orientations, comprising:
a rest orientation in which the platform abuts the ground and the upright frame extends vertically; and
a tilted orientation configured to move an item in which the platform is tilted upward and elevated above the ground at an incline and the upright frame is tilted rearward at an incline;
a lower pair of lower arms coupled to the upright frame and positioned at the platform and oriented to extend forwardly from the upright frame and the pair of wheels;
the lower pair of lower arms forming a lower open-ended slot;
an upper pair of upper arms coupled to the upright frame and positioned closer to the handle and spaced-apart from the lower pair of lower arms, and oriented to extend forwardly from the upright frame and the pair of wheels;
the upper pair of upper arms forming an upper open-ended slot;
the upper and lower pairs of arms being vertically aligned and the upper and lower slots being vertically aligned;
the upper pair of upper arms being pivotally coupled to the upright frame; and
the upper pair of upper arms pivoting between at least two orientations, including:
an extended orientation extending forward in the rest orientation;
a retracted orientation against the upright frame; and
a lock locking the upper pair of upper arms in a selected orientation.
